(19) United States
(12) Patent Application Publication
(10) Pub. No.: US 2013/0295254 A1
(43) Pub. Date: Nov. 7, 2013

(54) INSTRUMENT FOR PRODUCING KAKIAGE AND METHOD FOR PRODUCING KAKIAGE

(71) Applicants: Kazuhide Maruyama, Tokyo (JP); Yasuhiko Iwahashi, Tokyo (JP); Tomofumi Kameoki, Tokyo (JP); Yoshihito Ueki, Tokyo (JP); Satoshi Kanazawa, Osaka (JP)

(72) Inventors: Kazuhide Maruyama, Tokyo (JP); Yasuhiko Iwahashi, Tokyo (JP); Tomofumi Kameoki, Tokyo (JP); Yoshihito Ueki, Tokyo (JP); Satoshi Kanazawa, Osaka (JP)

(73) Assignee: Nisshin Foods Inc., Tokyo (JP)

(21) Appl. No.: 13/980,835

(22) PCT Filed: Jan. 16, 2012
(86) PCT No.: PCT/JP2012/050691

§ 371 Date: Jul. 19, 2013

(30) Foreign Application Priority Data
Jan. 20, 2011 (JP) 2011-009667

(51) Int. Cl. A47J 37/12; A23L 1/01

(52) U.S. Cl. CPC A47J 37/1295; A23L 1/0107
USPC 426/438; 99/403

(57) ABSTRACT

An instrument for producing kakiage has a kakiage containing portion which includes a tubular mold having both end portions in an axis direction being opened and a plurality of through-holes formed therein, and a bottom plate fixed to an opening portion at one end of the tubular mold and having a plurality of through-holes formed therein, the bottom plate being fixed to the opening portion at the end of the tubular mold such that a given gap is formed between an end portion of the tubular mold and a periphery of the bottom plate.

### TECHNICAL FIELD

The present invention relates to an instrument for producing kakiage and a method for producing kakiage using the instrument, and in particular, an instrument for producing kakiage which is suitable for producing thick kakiage. “Kakiage” here refers to a kind of tempura which is made by battering whole or chopped ingredients and deep-frying the battered ingredients.

### BACKGROUND ART

Use of a tubular mold has been conventionally proposed to produce kakiage in a uniform shape. For example, Patent Literature 1 discloses a method for producing kakiage including the steps of placing, in a frying oil vessel, a tubular mold in which a plurality of through-holes are formed, pouring kakiage batter into the mold, and heating the kakiage batter in the mold while shaping it.

The tubular mold disclosed in Patent Literature 1, however, requires a process of shaping kakiage in the frying oil vessel, and the shape of kakiage may be damaged during the shaping process.

Accordingly, Patent Literatures 2 and 3, for example, disclose molds having bottom plates for producing well-shaped kakiage.

The instrument disclosed in Patent Literature 2 has a bottom plate and a tubular mold in each of which a plurality of through-holes are formed, and the mold is attached to the bottom plate in such a manner that the mold can be swung upward from the bottom plate, Kakiage batter poured into the tubular mold with a bottom thereof being covered by the bottom plate and heated, and the mold is then swung upward from the bottom plate so that the kakiage batter leaves from the bottom plate and falls down from the mold to be released in the frying oil vessel.

On the other hand, the instrument disclosed in Patent Literature 3 has a tubular mold in which a plurality of through-holes are formed and a planar bottom plate having no through-hole, and the mold is attached to the bottom plate in such a mariner that the mold can be slid upward from the bottom plate. Kakiage batter is poured into the mold with a bottom thereof being covered by the bottom plate and heated, and then the mold is slid upward from the bottom plate to be separated from the bottom plate so that the tubular mold is pulled upward from the kakiage batter.

### CITATION LIST

### Patent Literature

Patent Literature 1: JP 2003-24217 A

Patent Literature 2: JP 2008-206700 A

Patent Literature 3: JP 3155316 U

### SUMMARY OF INVENTION

### Technical Problems

Well-shaped kakiage can be produced by using a mold having a bottom plate like the instruments disclosed in Patent Literatures 2 and 3.

However, there is a problem that kakiage batter is likely to stick to the bottom plate, and a part of kakiage batter may remain on the bottom plate as a residue when the tubular mold is swung or is slid upward from the bottom plate. If a residue is left on the bottom plate in this way, kakiage batter newly introduced at the next time of producing kakiage binds with the residue, making it more difficult for kakiage batter to come off or impairing the appearance of the produced kakiage to thereby reduce the commercial value thereof. Thus, continuous production may become difficult.

In addition, in order to produce thicker kakiage, it is necessary to set the height of the tubular mold to be high, and there is a problem that kakiage batter does not fall or hardly falls off downward from the mold by only swinging or sliding the mold upward from the bottom plate, making the production difficult.

The invention was made to solve such the conventional problems and has an object to provide an instrument for producing kakiage which can produce thick kakiage with ease and good productivity.

Furthermore, the invention has another object to provide a method for producing kakiage using the above-described instrument for producing kakiage.

### Solution to Problems

The instrument, for producing kakiage according to the invention comprises a kakiage containing portion which includes a tubular mold having both end portions in an axis direction being opened and a plurality of through-holes formed therein; and a bottom plate fixed to an opening portion at one end of the tubular mold and having a plurality of through-holes formed therein, wherein the bottom plate is fixed to the opening portion at the end of the tubular mold such that a given gap is formed between an end portion of the tubular mold and a periphery of the bottom plate. For instance, by fixing a bottom plate which is smaller than an opening portion at one end of the tubular mold to the opening portion at the end of the tubular mold, a gap facing in the axial direction of the mold is formed between the inner circumferential surface at the lower end of the mold and the periphery of the bottom plate, or by locating and fixing a bottom plate to be lower from the lower end surface of the mold for a given amount, a gap facing in the direction perpendicular to the axial direction of the mold is formed between the lower end surface of the mold and the upper surface of the periphery of the bottom plate.

Preferably, the plurality of through-holes in the bottom plate account for an opening ratio of 70% to 95% with respect to a whole area of the bottom plate being assumed to have no through-hole.

The plurality of through-holes in the bottom plate may include a plurality of kinds of through-holes having different diameters from one another. As an example, the bottom plate may be configured to have the plurality of through-holes including a plurality of first through-holes having a diameter of 7 mm to 15 mm and a plurality of second through-holes having a diameter of 1 mm to 5 mm,

The tubular mold preferably has an inner diameter of 5 cm to 15 cm and a height of 2 cm to 10 cm, and more preferably has an inner diameter of 7 cm to 12 cm and a height of 3 cm to 8 cm.

Moreover, the instrument for producing kakiage may comprise: a plurality of kakiage containing portions; a joining member for joining the plurality of kakiage containing portions such that respective bottom plates are positioned on a same plane; and a handle unit for holding the plurality of kakiage containing portions jointed by the joining member.

The method for producing kakiage according to the invention comprises the steps of: locating the kakiage containing portion of the above-described instrument for producing kakiage in a frying oil vessel which is heated to a temperature suitable for deep-frying; pouring kakiage batter into the kakiage containing portion; deep-frying the kakiage batter in the kakiage containing portion; and lowering the kakiage containing portion in the frying oil vessel to pull the fried kakiage batter out the kakiage containing portion upward so as to float the kakiage batter in the frying oil vessel. The floating kakiage batter is further deep-fried as in the state or after being turned over to thereby produce kakiage.

As the frying oil vessel used in the method, one normally used to produce deep-fried products such as kakiage and tempura may be appropriately used.

As the kakiage batter to be used in the production method, batter materials and ingredients that are normally used to produce kakiage may be used. A specific example thereof includes one made by adding water in a batter Material containing flour, various starches, albumen powder, sugars, a leavening agent, a thickener, an emulsifier, fat, salt, seasoning or others and then appropriately adding, for example, seafoods such as shrimp, squid and fish and vegetables such as onion, green onion and burdock.

As the oil to be used for deep-frying, any oil used to produce deep-fried products including kakiage and tempura may be appropriately used. Examples thereof include vegetable oils such as rapeseed oil, soybean oil, sunflower oil, safflower oil, cottonseed oil, olive oil, cacao oil, palm oil and corn oil, and animal oils such as beef tallow oil and lard, which may be used singly or in a mixture of two or more kinds.

### Advantageous Effects of Invention

According to the invention, since the bottom plate in which a plurality of through-holes are formed is fixed to an opening portion at one end of the tubular mold to form a given gap between the end of the tubular mold and the periphery of the bottom plate, kakiage batter can easily come out the kakiage containing portion upward by only lowering the kakiage containing portion in the frying oil vessel, enabling to produce thick kakiage with ease and good productivity.

### BRIEF DESCRIPTION OF DRAWINGS

FIG. 1 is a front view illustrating an instrument for producing kakiage according to an embodiment of the invention.

FIG. 2 is a bottom view illustrating the instrument for producing kakiage according to the embodiment.

FIG. 3 is a perspective view illustrating a kakiage containing portion used in the instrument for producing kakiage according to the embodiment.

FIG. 4 is a front view illustrating a kakiage containing portion used in the instrument for producing kakiage according to the embodiment.

FIG. 5 is a bottom view illustrating a kakiage containing portion used in the instrument for producing kakiage according to the embodiment.

FIGS. 6A and 6B show states of producing kakiage, FIG. 6A being a front view illustrating kakiage batter in the kakiage containing portion being deep-fried, FIG. 6B being a front view illustrating the kakiage containing portion being lowered in the frying oil vessel and the fried kakiage batter floating in the frying oil vessel.

FIG. 7 is a perspective view illustrating a flow of oil when the kakiage containing portion is lowered in the frying oil vessel.

FIG. 8 is a partial sectional view illustrating a flow of oil when the kakiage containing portion is lowered in the frying oil vessel.

FIG. 9 is a partial sectional view illustrating a flow of oil when the kakiage containing portion of an instrument for producing kakiage according to a modified embodiment is lowered in the frying oil vessel.

### DESCRIPTION OF EMBODIMENTS

The invention is described below in detail based on a preferred embodiment shown in the accompanying drawings.

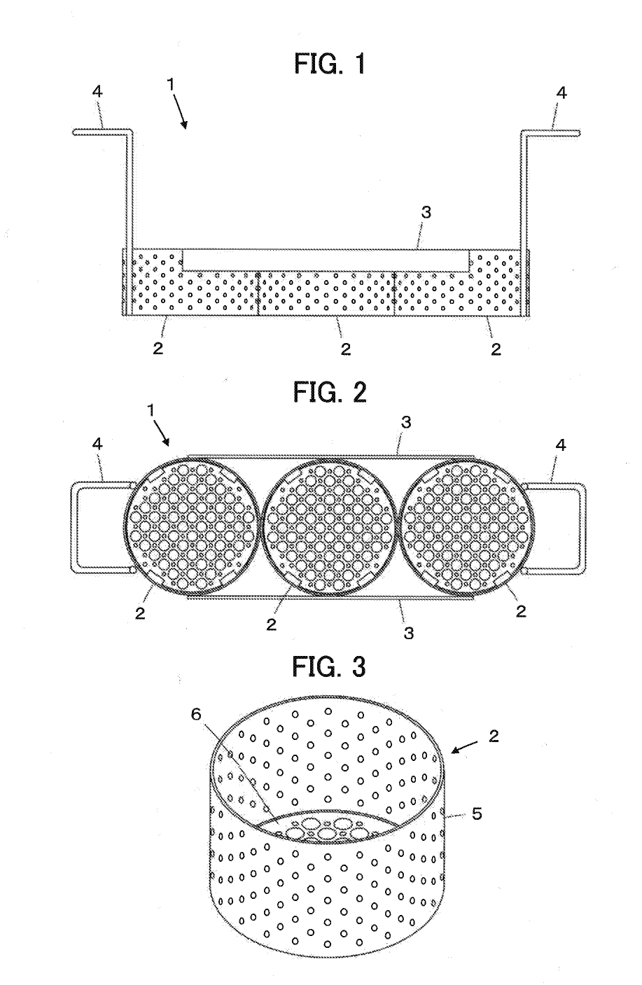

FIG. 1 and FIG. 2 illustrate the configuration of an instrument for producing kakiage 1 according to an embodiment of the invention. The instrument for producing kakiage 1 includes three kakiage containing portions 2 having the same structure as each other, and the three kakiage containing portions 2 are linearly aligned and are joined together by a pair of joining members 3 to form an integral assembly. Among the three kakiage containing portions 2, kakiage containing portions 2 at both ends in the alignment are each provided with a handle 4.

As illustrated in FIG. 3, each kakiage containing portion 2 includes a cylindrical mold or circular tube shaped mold 5 having a central axis extending in a vertical direction and both end portions in the axial direction being opened, and'a disc-shaped bottom plate 6 fixed to the lower end of the mold 5 so as to totally form a so-called cup-like shape having an opened upper end.

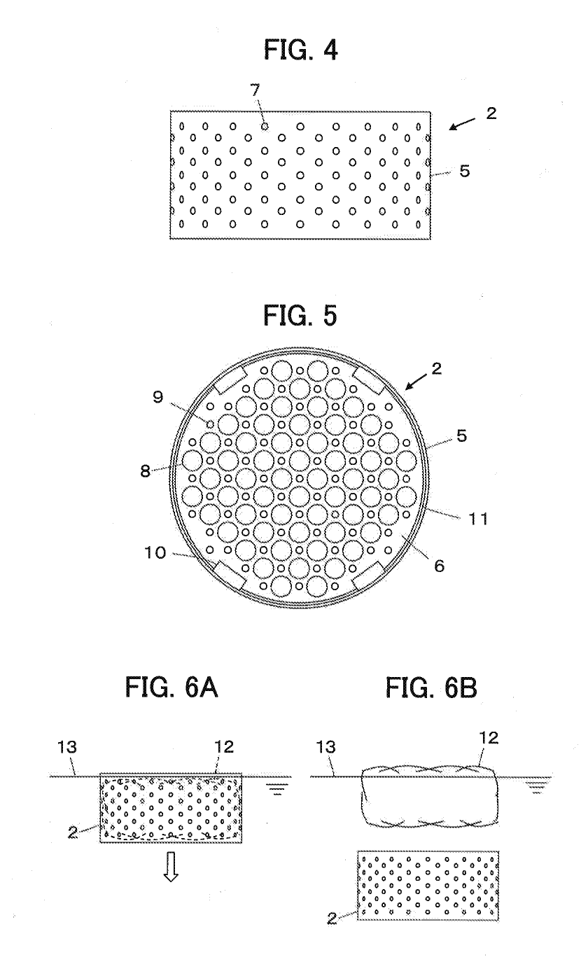

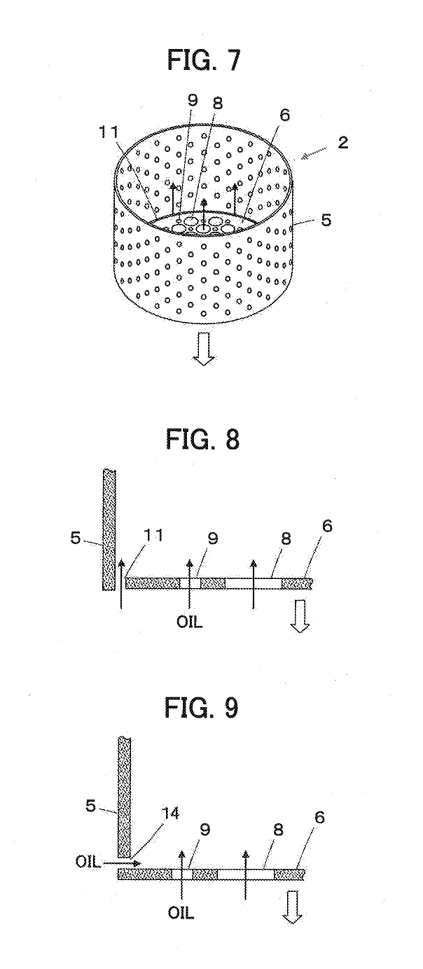

As illustrated in FIG. 4, a plurality of through-holes 7 having a given diameter are arranged and formed over the whole region of the cylindrical mold 5.

Similarly, as illustrated in FIG. 5, a plurality of first through-holes 8 having a relatively large diameter and a plurality of second through-holes 9 having a relatively small diameter are formed so as to be alternately arranged over the whole region of the bottom plate 6. That is, one second through-hole 9 is arranged between two adjacent first through-holes 8. In addition, the bottom plate 6 has a smaller diameter than the inner diameter of the cylindrical mold 5 and is fixed within the opening portion at the lower end of the cylindrical mold 5 via four connecting pieces 10. As a result, four arc-shaped gaps 11 of a given width are formed between the inner circumferential surface at the lower end of the mold 5 and the periphery of the bottom plate 6.

The kakiage containing portions 2, the joining members 3 and the handles 4 are respectively made of stainless steel. The joining members 3 are firmly fixed to the respective three kakiage containing portions 2 by soldering or the like so that the three kakiage containing portions 2 are jointed with one another such that the respective bottom plates 6 are positioned on a same plane. The handles 4 are also firmly fixed to the kakiage containing portions 2 at both ends of the alignment, respectively, by soldering or the like. Locations and a number of the arranged handles 4 can be appropriately selected depending on the shape of the frying oil vessel or deep fryer to be used and the size of each kakiage containing portion 2. The handles 4 may be firmly fixed to other locations than the kakiage containing portions 2.

A method for producing kakiage by using the above-described instrument for producing kakiage 1 will be described.

First, holding the instrument for producing kakiage 1 via the handles 4, the kakiage containing portions 2 are located in the frying oil vessel as illustrated in FIG. 6A. In this state, kakiage batter 12 is poured into each of the kakiage containing portions 2 and is deep-fried in each of the kakiage containing portions 2. At this time, the kakiage containing portions 2 are sunk in the frying oil vessel until the upper ends thereof almost agree with the surface of deep-frying oil 13, and the kakiage batter 12 spreads to the depth of each kakiage containing portion 2 and hardens.

Once the kakiage batter 12 is deep-fried until the surface thereof hardens, the kakiage containing portions 2 are lowered in the frying oil vessel by using the handles 4 as illustrated in FIG. 6B. Accordingly, the kakiage batter 12 comes out the kakiage containing portions 2 upward and floats in the frying oil vessel.

Thereafter, the kakiage batter 12 is further deep-fried as in the state or after being turned over, and when sufficiently fried, the kakiage batter 12 is taken out from the deep-frying vessel to terminate the production of kakiage.

Since the plurality of first through-holes 8 and the plurality of second through-holes 9 are arranged and formed in the bottom plate 6 of each kakiage containing portion 2 to form the arc-shaped gaps 11 between the inner circumferential surface at the lower end of the mold 5 and the periphery of the bottom plate 6, when each kakiage containing portion 2 is lowered in the frying oil vessel, oil in the frying oil vessel relatively flows into the kakiage containing portion 2 through the plurality of first through-holes 8 and the plurality of second through-holes 9 in the bottom plate 6 and the gaps 11 at the periphery of the bottom plate 6. Owing to the flow of oil, the kakiage batter 12 in the kakiage containing portion 2 can leave from the upper surface of the bottom plate 6 and the inner circumferential surface of the cylindrical mold 5 in a good condition and can come out from the kakiage containing portion 2 without damaging the shape of kakiage and leaving a residue thereof in the kakiage containing portion 2.

Hence, even thick kakiage can be easily produced, and continuous production becomes possible.

For example, the mold 5 of each kakiage containing portion 2 is formed to have an inner diameter of 5 cm to 15 cm and a height of 2 cm to 10 cm. With this size, voluminous kakiage which has been favored in recent years can be produced. An example of the through-hole 7 in the mold 5 has a diameter of 1 mm to 5 mm.

In the bottom plate 6, while the exemplary first through-hole 8 has a diameter of 7 mm to 15 mm, and the exemplary second through-hole 9 has a diameter of 1 mm to 5 mm, the total area of openings of the plurality of first through-holes 8 and the plurality of second through-holes 9 preferably accounts for an opening ratio of 70% to 95% with respect to the whole area of the bottom plate 6 which is assumed to have no through-hole.

As the opening ratio is higher, the kakiage batter 12 better comes off from the kakiage containing portion 2 in the frying oil vessel, but if a shape having an opening ratio of higher than 95% such as a metal mesh shape is adopted to the bottom plate, the kakiage batter 12 is likely to stick thereto, and a residue will remain. Or, the kakiage batter 12 drops down through the mesh holes and hardens, possibly making it difficult to come off or impairing the appearance of kakiage. Thus, when the opening ratio exceeds 95%, disadvantages may arise in both quality of the product and processability.

Meanwhile, if the diameters of the respective through-holes in the bottom plate 6 are too large, ingredients of kakiage such as vegetables may protrude through the through-holes to be caught in the through-holes. In addition, the kakiage batter 12 drops down through the bottom plate 6 so that it becomes difficult for the kakiage batter 12 to come off from the bottom plate 6, impairing the appearance of kakiage.

Hence, in the instrument for producing kakiage 1 according to the embodiment, the opening ratio of 70% to 95% is achieved by alternately arranging the first through-holes 8 having a diameter of 7 mm to 15 mm and the second trough-holes 9 having a diameter of 1 mm to 5 mm, enabling the kakiage batter 12 to easily come off from the bottom plate 6 and improving the processability.

In addition, by making the bottom plate 6 smaller than the opening portion at the lower end of the cylindrical mold 5, the gaps 11 are formed between the inner circumferential surface at the lower end of the mold 5 and the periphery of the bottom plate 6. Accordingly, the kakiage batter 12 is not likely to remain in a corner of the kakiage containing portion 2, and the kakiage batter 12 can easily come off from the bottom plate 6.

In the embodiment of the invention, it is preferable that the diameter of the bottom plate 6 be smaller than the inner diameter of the cylindrical mold 5 to form the arc-shaped gaps 11 facing in the axis direction, i.e., the vertical direction, between the inner circumferential surface at the lower end of the mold 5 and the periphery of the bottom plate 6. However, as illustrated in FIG. 9, the diameter of the bottom plate 6 may be almost identical to the outer diameter of the cylindrical mold 5 while the bottom plate 6 is located and fixed to be lower from the lower end surface of the mold 5 for a given amount, so that a ring-like gap 14 facing in the direction perpendicular to the axial direction, i.e., the horizontal direction, may be formed between the lower end surface of the mold 5 and the upper surface of the periphery of the bottom plate 6. Even with this configuration, once the kakiage containing portion 2 is lowered in the frying oil vessel, oil in the frying oil vessel flows into the kakiage containing portion 2 via the plurality of first through-holes 8 and the plurality of second through-holes 9 in the bottom plate 6 as well as the gap 14 at the periphery of the bottom plate 6, so that the kakiage batter 12 in the kakiage containing portion 2 can leave from the upper surface of the bottom plate 6 and the inner circumferential surface of the cylindrical mold 5 in a good condition and can come out from the kakiage containing portion 2 without damaging its appearance and leaving a residue.

Moreover, each kakiage containing portion 2 includes the mold 5 in a cylindrical shape and the bottom plate 6 in a disc-like shape, but this is not the sole case, and a mold in an angular tube shape and a bottom plate of a shape corresponding to such the mold may be used.

In addition, in the above-described embodiment, three kakiage containing portions 2 are joined with one another. However, the instrument for producing kakiage can also be configured to have one kakiage containing portion 2, two kakiage containing portions 2, or four or more kakiage containing portions 2.

### DESCRIPTION OF SYMBOLS

1 instrument for producing kakiage

2 kakiage containing portion

3 joining member

4 handle

5 mold

6 bottom plate

7 through-hole

8 first through-hole

9 second through-hole
10 connecting piece
11, 14 gap
12 kakiage batter
13 surface of deep-frying oil

1. An instrument for producing kakiage comprising a kakiage containing portion which includes a tubular mold having both end portions in an axis direction being opened and a plurality of through-holes formed therein, and a bottom plate fixed to an opening portion at one end of the tubular mold and having a plurality of through-holes formed therein,
wherein the bottom plate is fixed to the opening portion at the end of the tubular mold such that a given gap is formed between an end portion of the tubular mold and a periphery of the bottom plate.

2. The instrument for producing kakiage according to claim 1, wherein the plurality of through-holes in the bottom plate account for an opening ratio of 70% to 95% with respect to a whole area of the bottom plate being assumed to have no through-hole.

3. The instrument for producing kakiage according to claim 1, wherein the plurality of through-holes in the bottom plate include a plurality of kinds of through-holes having different diameters from one another.

4. The instrument for producing kakiage according to claim 3, wherein the plurality of through-holes in the bottom plate have a plurality of first through-holes having a diameter of 7 mm to 15 mm and a plurality of second through-holes having a diameter of 1 mm to 5 mm.

5. The instrument for producing kakiage according to claim 1, wherein the tubular mold has an inner diameter of 5 cm to 15 cm and a height of 2 cm to 10 cm.

6. The instrument for producing kakiage according to claim 1 comprising:
a plurality of the kakiage containing portions;
a joining member for joining the plurality of kakiage containing portions such that respective bottom plates are positioned on a same plane; and
a handle unit for holding the plurality of kakiage containing portions jointed by the joining member.

7. A method for producing kakiage, comprising the steps of locating the kakiage containing portion of the instrument for producing kakiage according to claim 1 in a heated frying oil vessel;
pouring kakiage batter into the kakiage containing portion;
deep-frying the kakiage batter in the kakiage containing portion; and
lowering the kakiage containing portion in the frying oil vessel to pull the fried kakiage batter out the kakiage containing portion upward so as to float the kakiage batter in the frying oil vessel.
